(19) United States
(12) Patent Application Publication
(10) Pub. No.: US 2002/0005991 A1
(43) Pub. Date: Jan. 17, 2002

(54) SURFACE LIGHT SOURCE DEVICE OF SIDE LIGHT TYPE

(76) Inventors: KAYOKO MASAKI, KAWAGUCHI-SHI (JP); KAZUMASA OSUMI, KAWAGUCHI-SHI (JP)

Correspondence Address: STAAS & HALSEY LLP, 700 11TH STREET, NW, SUITE 500, WASHINGTON, DC, 20001, US

(21) Appl. No.: 08/772,259

(22) Filed: Dec. 23, 1996

(30) Foreign Application Priority Data
Dec. 28, 1995 (JP) 353853/1995

(51) Int. Cl. G02B 5/02; G02B 13/20

(52) U.S. Cl. 359/599

(57) ABSTRACT

A surface light source device of side light type and a prism sheet to be used in the device are improved in such a manner that a reflecting sheet is prevented from being seen as observed from the exiting surface side, thus improving the quality of illumination light to be emitted from the exiting surface. The prism sheet (12) disposed along the exiting surface of a light guide plate of the device is a light permeable sheet made of, for example, polycarbonate and having a prismatic surface on at least one side relatively near a scattering light guide plate (2). The prismatic surface has many projections extending substantially parallel to the incidence end surface (T) of the scattering light guide plate (2) and repeatedly arranged from the side of incidence end surface (T) toward the distal end of a wedge shape of the light guide plate (2). The prism sheet (12) allows the main component of illumination light (L1) from the scattering light guide plate (2) to come inside from the light-source-side slopes (M1) of the projections and then emits the main component from the roughened existing slopes (M2) with diffused reflection, thus widening the angle of propagation of light while correcting curb the main emitting direction of illumination light frontwards relative to the exiting surface.

### BACKGROUND OF THE INVENTION

1. Field of the Invention

This invention relates to a surface light source device of side light type to be applied to a liquid crystal display and the like, and more particularly to a surface light source device of side light type, in which a light guide plate directive in light emission is used, and a light control element suitable for use in the device.

2. Description of the Related Art

It has been a common practice to reduce a surface light source device of side light type in thickness for use in a back lighting arrangement in a liquid crystal display panel or the like. The surface light source device of side light type includes a light guide plate and a primary light source disposed sideways of the light guide plate. The primary light source is a rod-like light source, such as a cold cathode ray tube, illumination light from which is introduced into the light guide plate from its incidence end surface. The light introduced into the light guide plate is emitted, as deflected, from the exiting surface of the light guide plate toward the liquid crystal panel.

The conventional surface light source devices of side light type are classified into two groups, one using a light guide plate having a substantially uniform thickness, and the other using a light guide plate gradually decreasing in thickness away from the primary light source.

FIG. 11 is an exploded perspective view showing the latter type surface light source device. For assembling the surface light source device 1, as shown in FIG. 11, a primary light source 3 is placed sideways of a light guide plate (a scattering light guide plate) 2 made of scattering light guide material, whereupon a reflecting sheet 4, the scattering light guide plate 2 and a prism sheet 5, which serves as a light control element, as well as a light diffusible sheet 6 are placed one over another into a laminate form.

The primary light source 3 for supplying light to the light guide plate 2 is formed by surrounding a fluorescence lamp 7 in the form of a cold cathode ray tube with a reflector 8 of a substantially semicircular cross section. From the open side of the reflector 8, illumination light comes in the incidence end surface of the light guide plate 2. The reflecting sheet 4 is in the form of a sheet-like regular reflecting member such as a metal foil or a sheet-like irregular reflecting member such as a white PET film.

The scattering light guide plate 2 is a light guide plate having a wedge-shape cross section. The material of the scattering light guide plate 2 is prepared by uniformly dispersing, in a matrix of, for example, polymethylmetacrylate (PMMA), light permeable particles having a refractive index different from that of the matrix.

FIG. 12 is a cross-sectional view taken along line A-A of FIG. 11. As is understood from FIG. 12, illumination light L is introduced into the scattering light guide plate 2 from the incidence end surface T relatively near the primary light source 3. The introduced illumination light L is propagated as it is scattered by the light permeable particles; or in the presence of a reflecting sheet having a reflecting sheet 4 for causing scattered reflection, the illumination light L is propagated as it is repeatedly reflected between a plane (hereinafter called “slope”) at the side of the reflecting sheet 4 and another plane (hereinafter called “exiting surface”) of the prism sheet 5 with additional scattered reflection by the reflecting sheet 4.

During this propagation of the illumination light L, the component of an angle less than a critical angle with respect to the exiting surface tends to be emitted from the exiting surface as the incidence angle with respect to the exiting surface is lowered upon every reflection on the slope side. The illumination light L1 to be emitted from the exiting surface undergoes scattering by light permeable particles in the scattering light guide plate 2 while propagated with scattered reflection by the reflecting sheet 4.

However, since its component of an angle less than the critical angle is emitted as the illumination light L1 is propagated with reflection on the slopes inclined with respect to the exiting surface in the propagating direction, the main emitting direction is inclined toward the distal end of the wedge shape as shown in FIG. 13 showing, on an enlarged scale, a portion B of FIG. 12. Therefore the surface light source device 1 of side light type, which generates illumination light L1 with directivity, is called “directive-emitting surface light source device of side light type”.

The prism sheet 5 serves to correct this directivity of emission. The prism sheet 5 is in the form of a light permeable sheet-like member of, for example, polycarbonate having a prismatic surface on one side relatively near to the scattering light guide plate 2. This prismatic surface has a great number of projections extending substantially parallel to the incidence end surface T of the scattering light guide plate 2 and are repeatedly arranged from the side of the incidence end surface T toward the distal end of the wedge shape of the scattering light guide plate 2.

The prism sheet 5 allows the main component of the illumination light L1 from the scattering light guide plate 2 to come inside from the light source side's slopes (hereinafter called the “light-source-side slopes”) M1 of the triangular projections, whereupon the prism sheet 5 reflects the main component by the slopes (hereinafter called the “exiting slopes”) M2 opposite to the light-source-side slopes M1 and then emits it after reflecting by the slopes M2.

As a result, the main emitting direction of the illumination light L1 is corrected to the frontal direction (normal direction) of the exiting surface. Through this action, the surface light source device 1 of side light type can emit the illumination light frontwards more efficiently as compared with the surface light source device of side light type using a light guide plate having a uniform thickness.

The light diffusible sheet 6 is the form of a light permeable sheet-like member of, for example, polycarbonate and is roughened at the incidence surface and/or the exiting surface. Thus the light diffusible sheet 6 diffuses the emitting light of the prism sheet 5 to secure a desired angle of field of vision when forming a liquid crystal display.

The light guide plate having a directivity of emission is formed into a wedge shape or a generally wedge shape using light permeable or semitransparent material and may have a light scattering film on the exiting surface and/or the back surface. The surface light source device of side light type using such light guide plate also can emit the illumination light to the front side efficiently.

However, in this surface light source device 1, when the exiting surface is observed from the front side, it is inevitable that the reflecting sheet 4 disposed under the scattering light guide plate 2 can be see-through. Therefore the color of the reflecting sheet 4 is recognized so that the quality of illumination or display is lowered.

As is understood from FIG. 14, the main component of the incoming illumination light of the light diffusible sheet 6 is a component reflected by the exiting-surface slopes M2 of the prism sheet 5. Then some of the component scattered by the scattering light guide plate 2 comes in from the light-source-side slopes M1 of the prism sheet 5.

Consequently, in the exiting surface of the light diffusible sheet 6, regions AR to be intensely illuminated and regions DR to be relatively faintly illuminated are repeatedly formed at minute distances corresponding to the shapes of projections of the prism sheet 5. In observing a liquid crystal panel illuminated from back side by illumination light of the surface light source device 1 of side light type, since the exiting surface of the light diffusible sheet 6 is seen through the crystal panel, the color of the reflecting sheet 4 disposed under the scattering light guide plate 2 is recognized via the relatively faintly illuminated regions DR so that the display quality would be affected.

### SUMMARY OF THE INVENTION

This invention has been proposed in order to overcome the foregoing problems. It is therefore an object of the invention to improve a surface light source device of side light type and a prism sheet, which is to be used in the device, in such a manner that a reflecting sheet is prevented from being seen as observed from the exiting-surface side, thus improving the quality of illumination light to be emitted from the exiting surface.

A light control element according to this invention is characterized by slopes provided with light diffusible surfaces so that a reflecting sheet is prevented from being seen from the exiting-surface side of a light guide plate of a surface light source device of side light type in which the light control element is used, thus improving the quality of illumination.

This invention is applied to a light control element having a prismatic surface on at least one side. The prismatic surface of the light control element has a great number of repeated projections having slopes inclined to the general plane of the light control element, the slopes provided with light diffusible surfaces.

Preferably, these great number of projections extend in one common direction and are repeated arranged in a direction perpendicular to the above-mentioned one common direction, each of the projections having a substantially triangular cross section.

This invention is embodied also by a surface light source device of side light type which allows illumination light to come inside from an incidence end surface of a light guide plate gradually decreasing in thickness away from the end surface and emits from an exiting surface of a plate-like member the illumination light as deflected. The surface light source device of side light type according to this invention includes a light control element disposed along its exiting surface and having a prismatic surface on at least one side toward the light guide plate, the prismatic surface having a great number of repeated projections having slopes inclined to the general plane of the light control element, the slopes defining light diffusible surfaces.

Preferably, these great number of projections extend in one common direction and are repeatedly arranged in a direction perpendicular to the above-mentioned one common direction, each of the projections having a substantially triangular cross section.

With this arrangement, the slopes of the projections of the prismatic surface formed on the light-guide-plate-side surface of the light control element, which is incorporated in the surface light source device of side light type, has a light diffusing function. As a result, the illumination light diffused by these slopes is emitted via the exiting surface of the prism sheet. Since the illumination light diffused by the slopes enters the exiting surface of the light control element substantially uniformly from inside, it is possible to retard the reflecting sheet from being seen from the exiting-surface side.

This invention will now be described more in detail with reference to the accompanying drawings.

### BRIEF DESCRIPTION OF THE DRAWINGS

FIG. 1 is a perspective view showing a prism sheet, which serves as a light control element to be used in a surface light source device of side light type according to one embodiment of this invention;

FIG. 2 is an exploded perspective view of a surface light source device of side light type in which the prism sheet of FIG. 1 is used;

FIG. 3 is an explanatory cross-sectional view of the prism sheet of FIG. 1;

FIG. 4 is a characteristic curve showing directivity in the absence of any prism sheet in the surface light source device of side light type of FIG. 2;

FIG. 5 is a characteristic curve showing an actual directivity in comparison with FIG. 4;

FIG. 6 is a cross-sectional view showing a modified prism sheet, in which the light-source-side slopes instead of the exiting-surface-side slopes are roughened;

FIG. 7 is a cross-sectional view showing another modified prism sheet, in which both the exiting-surface-side slopes and the light-source-side slopes are roughened;

FIG. 8 is a cross-sectional view showing still another modified prism sheet, in which the exiting-surface-side slopes and the light-source-side slopes are asymmetrical;

FIG. 9 is a perspective view showing a further modified prism sheet, which has projections on both the incidence surface and the exiting surface;

FIG. 10 is a perspective view showing an additional modified prism sheet according to another embodiment;

FIG. 11 is an exploded perspective view showing a conventional surface light source device of side light type;

FIG. 12 is a cross-sectional view taken along line A-A of FIG. 11;

FIG. 13 is a cross-sectional view explaining the manner in which a prism sheet and a light diffusible sheet act in the conventional surface light source device of side light type of FIG. 11; and

FIG. 14 is an explanatory cross-sectional view in connection with the prism sheet and the light diffusible sheet of FIG. 13.

### DETAILED DESCRIPTION OF THE PREFERRED EMBODIMENTS

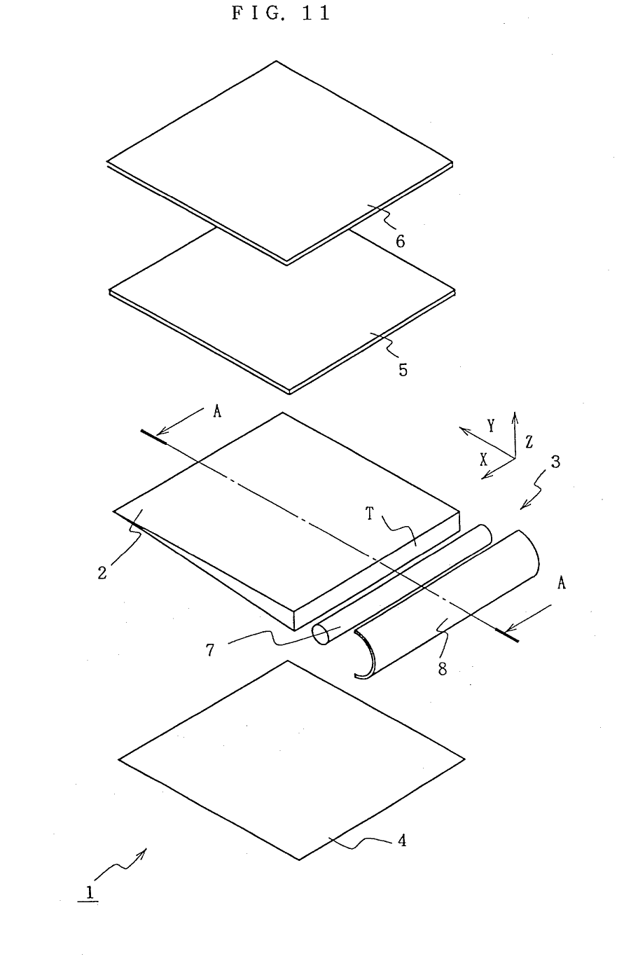

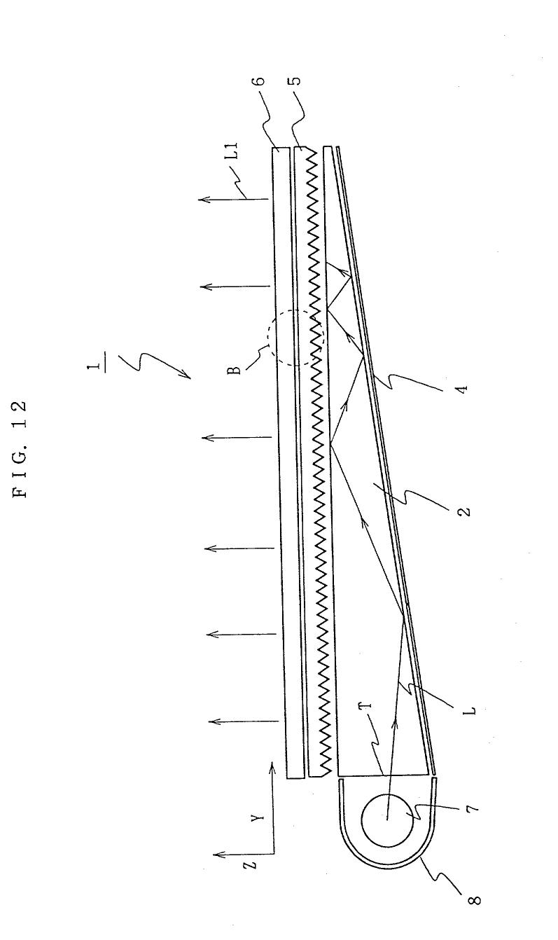

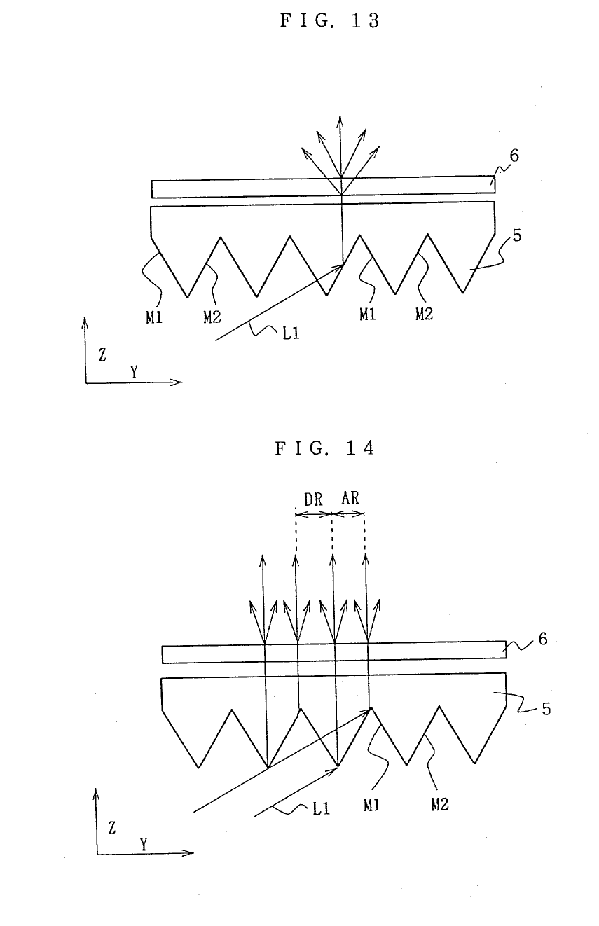

FIG. 2 is a perspective view showing a surface light source device of side light type according to a first embodiment of this invention. Regarding the surface light source device 10 of side light type, parts or elements similar to those of the conventional surface light source device of FIGS. 11 and 12 are designated by like reference numerals, and repetition of description is omitted here.

A reflecting sheet 11 is disposed along an inclined side of a scattering light guide plate 2 which receives light supply from a fluorescent lamp 6. The reflecting sheet 11 is a regular reflection sheet-like member evaporated of silver and sends back illumination light, which leaks from the inclined surface of the scattering light guide plate 2, efficiently into the scattering light guide plate 2.

On the other hand, a prism sheet 12 disposed along the exiting surface of the scattering light guide plate 2 as a light control element is a composite element serving as the prism sheet 5 and the light diffusible sheet 6 described in connection with FIG. 11. Accordingly the surface light source device 10 of side light type does not require a separate light diffusible sheet and hence is simple in whole construction.

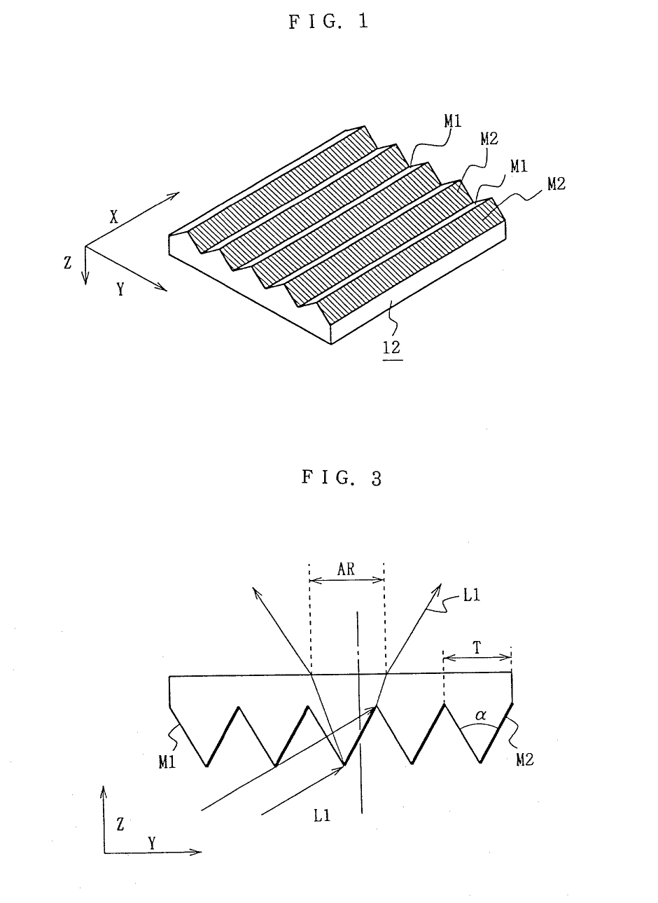

FIG. 1 is a perspective view of the prism sheet 12 as seen from the side of the scattering light guide plate 2. In FIG. 1, the prism sheet 12 is a light permeable sheet made of, for example, polycarbonate and has a prismatic surface on one surface relatively near the scattering light guide plate 2. This prismatic surface has a great number of projections extending substantially parallel to an incidence end surface T of the scattering light guide plate 2 and are repeatedly arranged from the side of the incidence end surface T toward the distal end of a wedge shape of the scattering light guide plate 2, each of the projections having a triangular cross section.

The prism sheet 12 allows a main component of illumination light L1 from the light-diffusible guide light plate 2 to come inside from the light-source-side slopes M1 of the projections and then reflects the illumination light by the exiting-surface slopes M2 corresponding to the light-source-side slopes Ml to emit the illumination light from the slopes M2, thereby correcting or curbing the main emitting direction of illumination light frontward relative to the exiting surface.

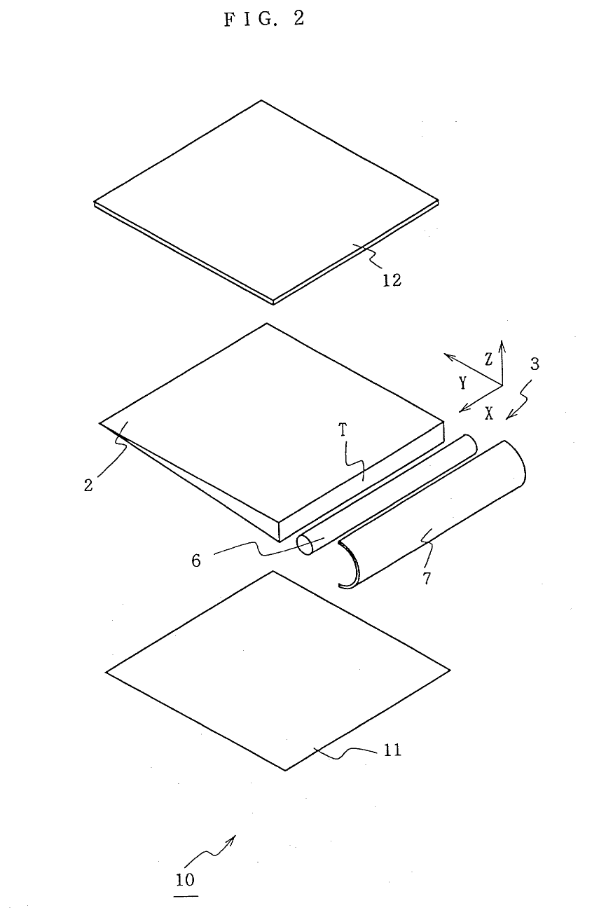

Further, in the prism sheet 12, the exiting-surface slopes M2 are roughened by sandblasting and hence serve as light-diffusible surfaces. Therefore, as shown in FIG. 3, reflection by the exiting-surface slopes M2 makes the illumination light L1 diffused and emitted from the exiting surface over a widened range of angle commensurate with the degree of roughness of the slopes M2. As a result, the surface light source device 10 of side light type can secure a desired angle of field of vision without using a separate light-diffusible sheet.

Furthermore, as the exiting-surface slopes M2 of the prism sheet 12 are roughened, it is possible to expand an exiting-surface-side region AR of the prism sheet 12 which region is to be illuminated by the illumination light L1 reflected by a single exiting-surface slope M2. Accordingly, it is possible to illuminate the exiting surface of the prism sheet 12 substantially uniformly from inside, thereby eliminating the region DR (FIG. 14) which would have been relatively less intensively illuminated with the conventional arrangement.

Therefore, in this embodiment, when the surface light source device 10 of side light type is observed from the exiting-surface side, metallic luster of the reflecting sheet 11 cannot be seen from that side.

Preferably, the size of the triangular projections and the degree of roughness of the rough surfaces should be selected under consideration of the principle that the illumination light L1 reflected by each exiting-surface slope makes each exiting-surface-side region AR of the prism sheet 12 expanded and illuminated.

Our experiments indicate that the prism sheet 12 of this invention emitted illumination light with a practically acceptable quality and secures a practically adequate angle of field of vision under the following condition:

Cross-sectional shape of projections: isosceles triangle

Pitch T of projections: 50 mm

Vertical angle α: ranging from 60° to 70°

Arithmetic mean roughness Ra (surface roughness according to JIS B0031-1994) of exiting-surface slopes M2: ranging from 0.01 to 0.05 mm

Mean roughness Rz of ten points of exiting-surface slopes M2: ranging from 0.1 to 0.5 mm where Ra and Rz are units of surface roughness according to JIS B0031-1994.

With regard to the angle of vertical angle α, assuming that the prism sheet 12 is actually installed in an equipment as a liquid crystal display panel, necessary directivity varies according to the type of the equipment; a preferable practical range of angle is from 55° to 75°.

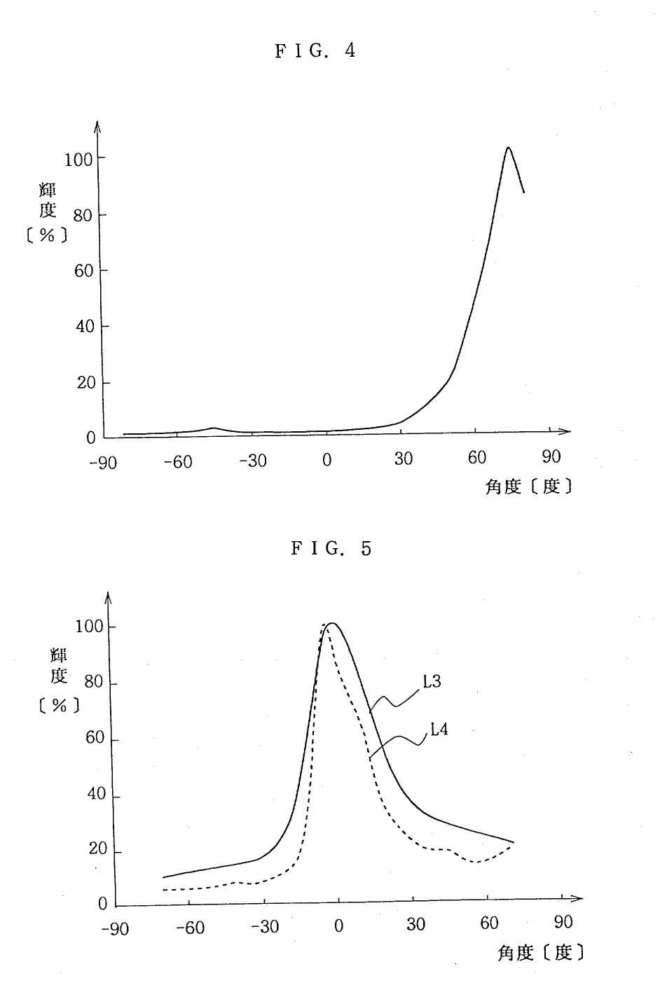

FIG. 4 is a characteristic curve showing directivity in the absence of the prism sheet 12 according to the foregoing condition. It is understood from this characteristic curve that illumination light was emitted in a direction inclined chiefly to the distal end of the wedge shape. In this measuring, the frontal direction (normal direction) of the exiting surface was defined as an angle of 0 degree, and the light-source side and the distal-end-of-wedge-shape side were defined as a negative direction and a positive direction, respectively.

To the contrary, FIG. 5 is a characteristic curve showing directivity in the case of the roughened exiting-surface slopes (symbol L3) in comparison with case of the unroughened exiting-surface slopes (symbol L4). In this case, it is understood that the angle of field of vision was expanded without a light diffusible sheet.

By thus roughening the exiting-surface slopes M2 of the prism sheet 12 to form a light diffusible surface, it is possible to illuminate the exiting surface of the prismatic surface 12 substantially uniformly for emission of illumination light. As a result, the color of the reflecting sheet 11 cannot be recognized when it is observed from the front side, thus improving the quality of illumination.

In the foregoing embodiment, the exiting-surface slopes M2 of the prism sheet 12 are roughened. But this invention should by no means be limited to this.

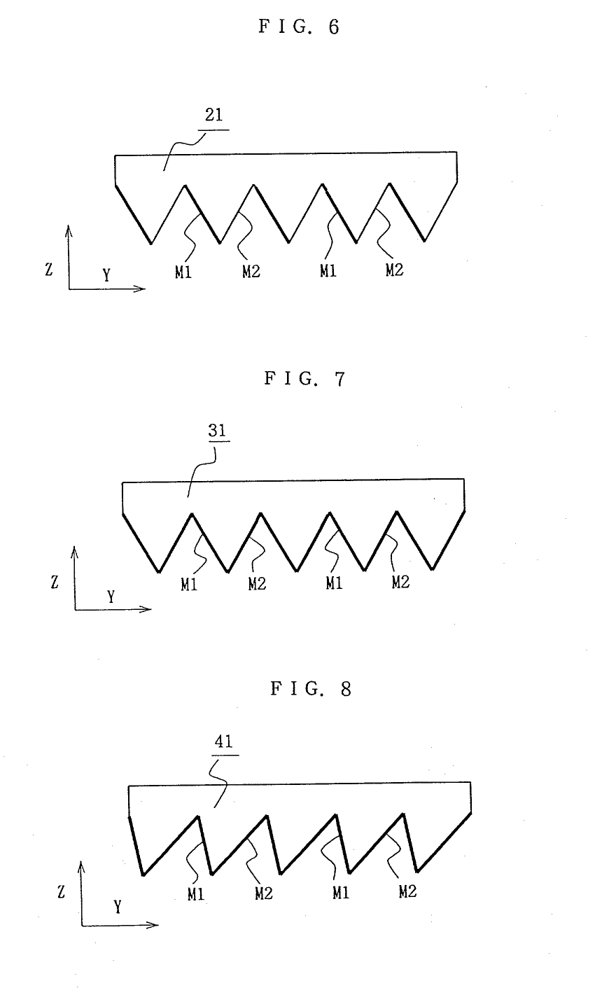

For example, the light-source-side slopes M1 may be roughened as shown in FIG. 6. In this case, illumination light incoming from the light-source-side slopes Ml is previously diffused and is directly reflected by the exiting-surface slopes M2, whereupon the illumination light is emitted from the exiting surface of the prism sheet 21. As a result, the exiting surface of the prism sheet 21 is uniformly illuminated so that the color of the reflecting sheet 11 cannot be recognized from the front side.

For example, like an alternative prism sheet 31 shown in FIG. 7, both the exiting-surface slopes M2 and the light-source-side slopes Ml may be roughened, achieving a similar result.

Further, in the foregoing embodiment, the prismatic surface are formed by a great number of repeated projections each having an isosceles triangular cross section; but this invention should by no means be limited to this illustrated example.

For example, like another alternative prism sheet 41 show in FIG. 8, the light-source-side slopes M1 and the exiting-surface slopes M2 are asymmetrical and are roughened, achieving a similar result. In this case, by selecting a range of 40° to 50° for the vertical angle α, the above-mentioned range for the degree of roughness of the slopes M1, M2 and the front side for the directivity, it is possible to secure a practically adequate quality of illumination and adequate angle of field of vision. Regarding the vertical angle α, a practical range of angle is from 40° to 55°.

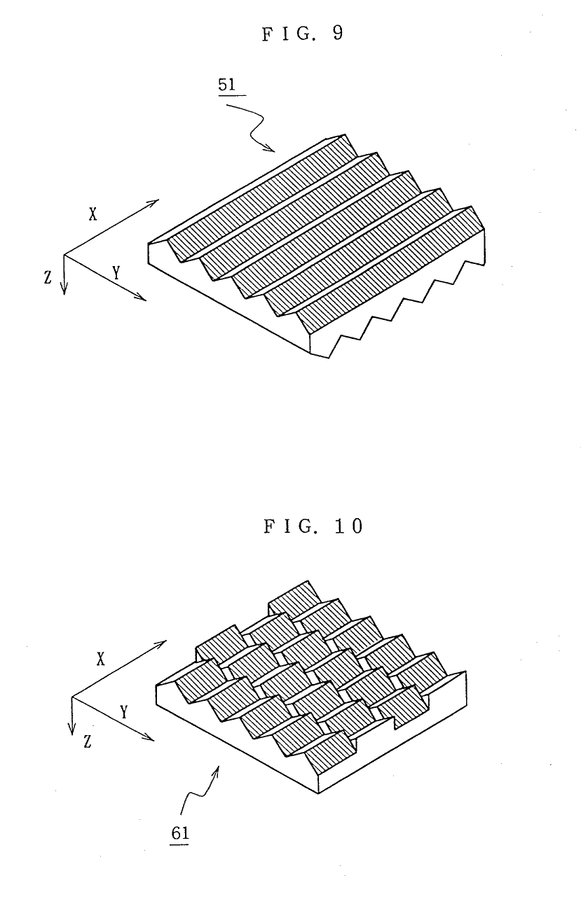

Furthermore, in the foregoing embodiment, the prismatic surface is formed on the side of the scattering light guide plate; but this invention should by no means be limited. For example, like still another alternative prism sheet 51 shown in FIG. 9, a prismatic surface may be formed on both surfaces. Namely, also in this case, for the prismatic surface on the side of scattering light guide plate, the light-source-side slopes and/or the exiting-surface slopes may be roughened, achieving a similar result.

In addition, in the foregoing embodiment, the prism sheet has a great number of parallel repeated projections each having a triangular cross section, but this invention should by no means be limited to this example; for example, as long as each of the repeated projections of triangular cross section has slopes inclined to the general plane of the prism sheet, the projections of a predetermined length may be varied in pitch little by little so that a wide variety of shapes of prism sheets can be obtained.

From another point of view, in the foregoing embodiment, the exiting-surface side of the prism sheet is not roughened to substantially define a mirror surface, but this invention should by no means be limited to this example. Namely, the exiting-surface side also may be roughened. With this structure, because of both the degree of roughness of the exiting-surface side and the degree of roughness of the incidence-surface side, it is possible to improve the quality of illumination light and to expand a selective angular range of field of vision.

From still another point of view, in the foregoing embodiment, the slopes of the prism sheet is roughened by sandblasting, but this invention should by no means be limited to this example. For example, the slopes of the prism sheet may be roughened by a wide variety of other methods, such as matting and chemical etching. As means equivalent to the rough surface, white ink may be printed on the slope to form the light diffusible surface.

Also regarding the light guide plate, this invention is not limited to the wedge shape in cross section and may be widely applied to a light source device of side light type in which a light guide plate having a directivity of emission is used.

Additionally regarding the incidence end surface of the light guide plate, it may be unnecessary that illumination light comes inside from only a single end surface. Namely, this invention can be applied also to a surface light source device of side light type in which illumination light comes inside from a plurality of end surfaces. The material of the light guide plate may not be made of scattering light guide material. This invention can be widely applied to a surface light source device of side light type in which a light guide plate with emission directivity is employed.

In the foregoing embodiment, this invention is applied to a liquid crystal display back lighting arrangement, but should by no means be limited to this example. This invention may be widely applied to illumination arrangements for various illuminators and displays.

What is claimed is:

1. A light control element having on at least one side a prismatic surface, wherein said prismatic surface has a great number of repeated projections having slopes inclined to the general plane of said light control element, at least part of said slopes defining a light diffusible surface.

2. A light control element according to claim 1, wherein said great number of projections extend in one common direction and are repeatedly arranged in a direction perpendicular to said one common direction, each of said great number of projections having a substantially triangular cross section.

3. A light control element according to claim 1 or 2, wherein said light diffusible surface is a rough surface.

4. A surface light source device of side light type, comprising:
a light guide plate having a varying thickness gradually decreasing away from its incidence end surface;
a primary light source for supplying illumination light to said light guide plate from said incidence end surface, the supplied light being deflected and emitted from an exiting surface of the light guide plate; and
a light control element disposed along the exiting surface of said light guide plate and having a prismatic surface on at least one side relatively near said light guide plate, said prismatic surface having a great number of repeated projections having slopes inclined to the general plane of said light control element, at least part of said slopes defining a light diffusible surface.

5. A surface light source device of side light type according to claim 4, wherein said great number of projections extend in one common direction and are repeatedly arranged in a direction perpendicularly to said one common direction, each of said great number of projections having a substantially triangular cross section.

6. A surface light source device of side light type according to claim 4 or 5, wherein said light diffusible surface is a rough surface.
